(19) United States
(12) Patent Application Publication
(10) Pub. No.: US 2024/0403202 A1
(43) Pub. Date: Dec. 5, 2024

(54) APPARATUS AND METHODS FOR AUTOMATICALLY CONFIGURING COMPUTING DEVICES UNDER TEST

(71) Applicant: Communications Test Design, Inc., West Chester, PA (US)

(72) Inventor: Stephen Tate DiJoseph, Downingtown, PA (US)

(73) Assignee: Communications Test Design, Inc., West Chester, PA (US)

(21) Appl. No.: 18/329,125

(22) Filed: Jun. 5, 2023

(51) Int. Cl. G06F 11/36; G06F 11/273

(52) U.S. Cl. CPC G06F 11/3688; G06F 11/2733; G06F 11/362

(57) ABSTRACT

This application relates to apparatus and methods for automatically configuring devices under test to allow for the loading of software, such as firmware and applications, onto the devices under test. In one example, a testing system includes a testing frame with multiple cabinets. Each cabinet houses a device, such as a smartphone. The testing system also includes a testing computer communicatively coupled to the devices, such as through a USB connection. The testing computer may receive, from a database, workflow data for each type of device. The workflow data characterizes a workflow to follow to configure each type of device. For each device, the testing computer determines human interface device (HID) actions based on the workflow data corresponding to the device. Further, the testing computer transmits the corresponding HID actions to each device, causing the devices to perform one or more configuration operations to allow for the loading of software.

### TECHNICAL FIELD OF THE DISCLOSURE

The disclosed embodiments relate generally to apparatus and methods for testing computing devices, and more particularly, to configuring and testing various computing devices.

### BACKGROUND

Computing devices, such as smartphones, personal computers, laptops, and tablets, among others, are widespread and employed for personal use as well as business use across a multitude of industries. These computing devices often must be configured and tested. For instance, before a customer purchases a new computing device, the new computing device may be loaded with particular software, and then tested to verify functionality. As another example, before reselling a refurbished computing device, the computing device may be configured and tested to assure it is functioning properly. Testing may include the verification of various hardware and software features of the computing devices. These processes, however, can be complicated, time consuming, and expensive, even more so when high numbers (e.g., hundreds, thousands, millions) of computing devices have to be tested.

### SUMMARY

The embodiments are directed to apparatus and methods to automatically configuring computing devices for the loading of software, such as firmware, and to testing the computing devices based on the loaded software. Computing devices may include, for example, smartphones, cellular phones, personal computers, laptops, and tablets, among others. For example, the embodiments may allow for the automatic and simultaneous loading of software on multiple computing devices. The plurality of computing devices may differ, and may execute varying software (e.g., firmware, operating system (OS), etc.). Further, and based on the loaded software, the embodiments may allow for the testing and verification of various functions of the plurality of computing devices, including software and hardware testing and verification operations. Further, the embodiments may determine results (e.g. status) of each of any loaded software as well as the verification and functional tests, and may provide the results for display.

For instance, in some embodiments, a testing computing device includes a memory device storing executable instructions, and at least one processor coupled to the memory device. The at least one processor is configured to execute the instructions to receive, from a database, workflow data for a device under test. The at least one processor is also configured to execute the instructions to determine a plurality of human interface device (HID) actions based on the workflow data. Further, the at least one processor is configured to execute the instructions to transmit the plurality of HID actions to the device under test, causing the device under test to perform one or more configuration operations.

In some embodiments, a method by at least one processor includes receiving, from a database, workflow data for a device under test. The method also includes determining a plurality of human interface device (HID) actions based on the workflow data. Further, the method includes transmitting the plurality of HID actions to the device under test, causing the device under test to perform one or more configuration operations.

In some embodiments, a non-transitory, machine-readable storage medium stores instructions that, when executed by at least one processor, cause the at least one processor to perform operations. The operations include receiving, from a database, workflow data for a device under test. The operations also include determining a plurality of human interface device (HID) actions based on the workflow data. Further, the operations include transmitting the plurality of HID actions to the device under test, causing the device under test to perform one or more configuration operations.

In some embodiments, a testing system includes a testing frame with a plurality of cabinets, each of the plurality of cabinets housing a device under test. The testing system also includes a testing computing device commutatively coupled to each of the devices under test. The testing computing device is configured to receive, from a database, workflow data for each of the devices under test. The testing computing device is also configured to determine, for each of the devices under test, a plurality of human interface device (HID) actions based on the workflow data corresponding to each device under test. Further, the testing computing device is configured to transmit to each of the devices under test the corresponding plurality of HID actions, causing each of the devices under test to perform one or more configuration operations.

### BRIEF DESCRIPTION OF THE DRAWINGS

FIG. 1 illustrates a device testing system, in accordance with some exemplary embodiments;

FIGS. 2A and 2B illustrate exemplary device screens, in accordance with some exemplary embodiments;

FIG. 3 illustrates a block diagram of a testing computing device, in accordance with some embodiments;

FIGS. 4A and 4B illustrate exemplary communications within the device testing system of FIG. 1, in accordance with some embodiments;

FIG. 5 is a flowchart of an exemplary process for automatically loading software onto a device under test, in accordance with some embodiments; and

FIG. 6 is a flowchart of an exemplary process for automatically loading software onto a plurality of devices under test, in accordance with some embodiments.

### DETAILED DESCRIPTION OF THE EMBODIMENT(S)

While the features, methods, devices, and systems described herein may be embodied in various forms, some exemplary and non-limiting embodiments are shown in the drawings, and are described below. Some of the components described in this disclosure are optional, and some implementations may include additional, different, or fewer components from those expressly described in this disclosure.

The embodiments described herein may allow for the automatic loading of software, such as firmware, to a device under test (DUT). The automatic loading of software may be performed according to a workflow that corresponds to the DUT. For example, the workflow may identify a particular message sequence for the DUT. In some instances, the loading operations include updating a memory device, such as a FLASH device, of the DUT with a version of firmware. Once the firmware is loaded, the loading operations may further include configuring the DUT using human interface device (HID) action messages, and installing a testing application on the DUT. The testing application, when executed by the DUT, allows for the testing of various hardware and/or software components of the DUT.

For instance, and as described herein, a testing system (e.g., testing assembly) may include a testing frame with a plurality of cabinets. Each cabinet may house a DUT. The DUT may be any computing device, such as a cellular phone (e.g., smart phone), laptop, computer, tablet, smart watch, or any other device that can communicate wirelessly. Each cabinet may also house additional equipment, such as a communication cable that attaches to the computing device under test. The communication cable may be, for instance, a universal serial bus (USB) (e.g., USB, USB 2.0, USB 3.0, etc.) cable (e.g., USB to USB, USB to Micro-USB, USB to USB-C, USB to lightning, etc.) that plugs into the device under test.

The testing system may also include a testing computing device that is communicatively coupled to each device under test. For example, a cable, such as a USB cable or Ethernet cable, may attach the testing computing device to an extending device, such as a hub, switch, or router. Further, the communication cables connected to the devices under test may also be connected to the extending device. In some instances, the testing computing device and devices under test may communicate wirelessly. For example, the testing computing device and devices under test may join a same wireless network, such as a WiFi® network.

Further, the testing computing device may execute an application that causes the testing computing device to generate and transmit messages over the communication cables to the DUTs within the cabinets. For instance, and as described herein, the testing computing device may generate and transmit a request to each DUT to obtain a configuration of the DUT. The request may cause the DUT to generate and transmit configuration data to the testing computing device. The configuration data may include, for example, a model of the DUT, a hardware version of the DUT, a software version of the DUT, or any other configuration information.

The testing computing device may then determine software loading workflow data for each DUT based on the configuration data received for each DUT. As described herein, the software loading workflow data may identify and characterize a messaging sequence to configure a corresponding DUT (e.g., type of DUT). The messaging sequence may correspond to possible selections across multiple user interface pages. In some examples, a database maintains software loading workflow data for each of a variety of DUTs. The testing computing device may determine, from the various software loading workflow data stored in the database, the software loading workflow data pertaining to a DUT based on the configuration data received for the DUT.

The table below shows an example of software loading workflow data. The table includes operations and corresponding parameter values. The notes column is merely to provide an explanation of each operation and its corresponding parameter values.

| | Parameter | |
|---|---|---|
| Operation | Values | Notes |
| reconnect | t: 100 | Place device in test (e.g., accessory) mode, |
| | | and wait 100 msecs. |
| wake | t: 100 | Turn device screen ON, and wait 100 msces. |
| click | 50; 75; | Click at pixel row location 50, column |
| | t: 200 | location 75, and wait 200 msecs. |
| click | 80:125; | Click at pixel row location 80, column |
| | t: 250 | location 125, and wait 250 msecs. |
| key | 15*down | Hit the down arrow key 15 times, and then hit |
| | enter | the Enter key (e.g., for clicking on icon). |
| back | t: 200 | Go to previous screen, and wait 200 msecs. |
| key | enter t: 275 | Hit the enter key and wait 275 msecs. |

The testing computing device may further execute the messaging sequence identified within the software loading workflow data. For instance, based on the software loading workflow data for a DUT, the testing computing device may generate one or more human interface device (HID) action messages. The HID action messages may characterize, for instance, user interface operations, such as a click of an icon, an enabling or disabling of an option, scrolling (e.g., scrolling up, scrolling down), or any other suitable operation. In some instances, the message sequence may also identify a time delay (e.g., 1 second, 5 seconds, a minute, etc.) between operations. The testing computing device may transmit the HID action messages to the DUT in accordance with the message sequence. When received, the HID action messages may cause the DUT to perform one or more configuration operations, such as enabling or disabling configuration settings. For instance, the configuration operations may include enabling or disabling configuration settings the DUT is displaying on a user interface. In some examples, the testing computing device transmits HID action messages to multiple DUTs simultaneously. For instance, the testing computing device may transmit a first HID action message to each one of multiple DUTS (e.g., sequentially), and may then transmit a second HID action message to each of the multiple DUTS. Each DUT may perform the configuration operations independently from each other (e.g., as they receive corresponding HID action messages).

In some instances, the testing computing device detects a DUT (e.g., type of device, firmware version, etc.), and generates and transmits firmware update messages (e.g., over USB) to the DUT to update the DUT's firmware. For example, each firmware update message may include a portion of executable instructions characterizing firmware. The firmware update messages may cause the DUT to update a FLASH memory with the updated firmware. Further, one the firmware is updated, the testing computing device generates and transmits HID action messages to the DUT that allow the DUT to proceed through an executed setup wizard. For instance, among other operations, the HID action messages may cause the DUT to enable a debug mode (e.g., a USB debug mode). The testing computing device may then generate and transmit debug messages to the DUT to configure DUT device settings, and to install a testing application, as described herein. In some examples, the testing computing device determines that the DUT has restarted after transmitting the HID action messages. For example, the testing computing device may attempt to receive a response from the DUT to a transmitted message. Once the testing computing device detects that the HUD has restarted, the testing computing device transmits the debug messages.

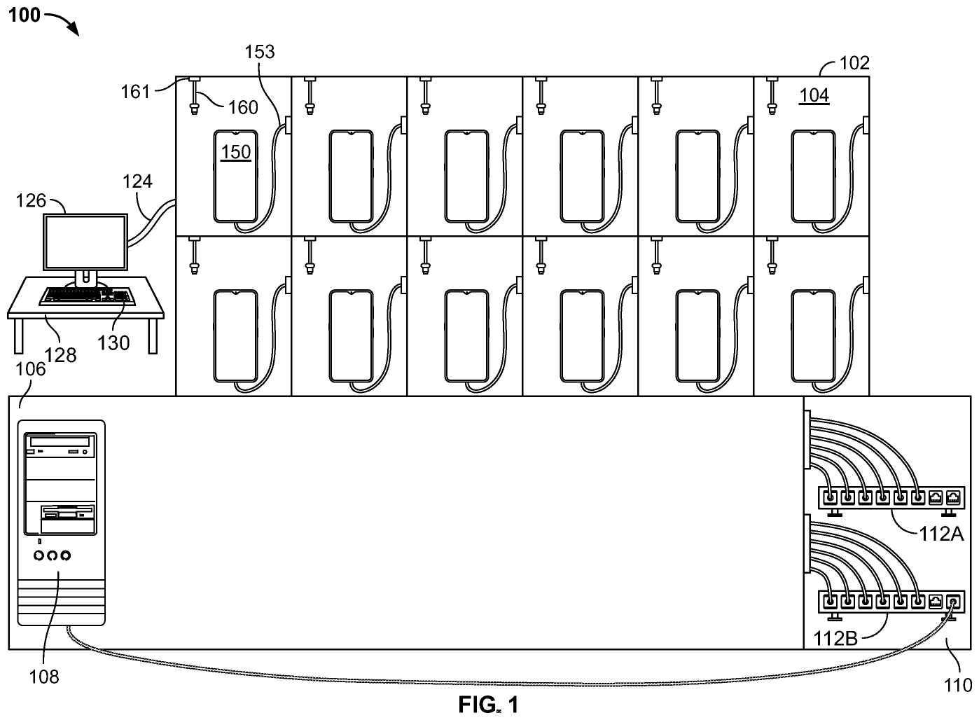

Referring to FIG. 1, a testing system 100 includes a testing frame 102 with a plurality of device cabinets 104. Each device cabinet 104 may include a device under test (DUT) 150 and a communication cable 153. The DUTs 150 can include, for instance, any computing device that can receive HID actions. For instance, DUTs 150 can be a cellular phone (e.g., an Android® device), a computer, a laptop, a tablet, or any other suitable computing device that supports HID actions. In some instances, one or more of the DUTs 150 may be of one type of computing device, and one or more of DUTs 150 may be of another type of computing device (e.g., where any one of the computer type, such as manufacturer and model, and operating system, differ from each other). Further, the testing computing device 108 may be any suitable computing device, such as a Windows® computer, a server (e.g., cloud-based server), or a laptop.

The testing frame 102 also includes a control cabinet 106 for storing a testing computing device 108, and one or more networking cabinets 110 for holding, for example, one or more extenders 112A, 112B (e.g., Ethernet hubs, USB hubs, switches, routers, etc.). The extenders 112A, 112B may allow for the exchange of data between the testing computing device 108 and one or more DUTs. For example, the testing computing device 108 may be connected to an extender 112A, 112B with a cable, such as a USB or Ethernet cable. Each of the DUTs 150 may also be connected to the extender 112A, 112B using the cables 153. As such, the testing computing device 108 may transmit data to each DUT 150, and may receive data from each DUT 150, via the extenders 112A, 112B. In some instances, the testing computing device 108 and one or more DUTs join a same wireless network, and can communicate over the wireless network.

The testing system 100 may also include a bracket 124 for securing a monitor 126 and a shelf 128 for a keyboard 130, which are communicatively coupled to the testing computing device 108. For instance, each of the monitor 126 and keyboard 130 may connect to the testing computing device 108 through a corresponding cable, such as a USB cable.

In some examples, the testing computing device 108 stores software loading workflow data in a memory device for various types of DUTs 150. For instance, the memory device may store first workflow data characterizing a first software loading workflow, second workflow data characterizing a second software loading workflow, and third workflow data characterizing a third software loading workflow. The first workflow data may correspond to a first type of DUT 150 (e.g., Apple® device), the second workflow data may correspond to a second type of DUT 150 (e.g., Android® device), and the third workflow data may correspond to a third type of DUT 150 (e.g., Google® device). The testing computing device 108 may obtain software loading workflow data for a particular DUT 150, and may generate and transmit messages to the DUT 150 in accordance with a messaging sequence defined by the software loading workflow data to configure the DUT 150 and/or update the DUT's 150 software.

For instance, the testing computing device 108 may determine a DUT's 150 type based on requesting, and receiving, configuration data for the DUT 150 (e.g., type, year, model number, software version, etc.). Based on the received configuration data, the testing computing device 108 may select one of the various software loading workflows. For instance, if the testing computing device 108 determines the configuration data identifies a first type of DUT 150, the testing computing device 108 may select the first workflow data. If, however, the testing computing device 108 determines the configuration data identifies a second type of DUT 150, the testing computing device 108 may select the second workflow data. Similarly, if testing computing device 108 determines the configuration data identifies a third type of DUT 150, the testing computing device 108 may select the third workflow data.

In some instances, the testing computing device 108 detects a DUT 150 (e.g., type of device, firmware version, etc.), and generates and transmits messages (e.g., over USB) to the DUT 150 to update the DUT's firmware. For example, the messages may cause the DUT 150 to update a FLASH memory with the updated firmware. Further, in some examples, based on detecting a DUT 150, the testing computing device 108 may generate and transmit debug messages to the DUT 150 to, for example, install a testing application, as described herein.

In some examples, the testing computing device 108 may generate and transmit to the DUT 150 one or more HID action messages in accordance with the selected workflow data. As described herein, the workflow data may correspond to an application, such as a setup wizard, that the DUT 150 executes. The HID action messages may indicate a selection (e.g., click) of a location on a user interface (e.g., the executed setup wizard). For instance, a first HID action message may indicate the selection (e.g., click) of a first icon (e.g., “START” icon) of the executed setup wizard. A second HID action message may indicate the selection of a second icon (e.g., “Accept all terms” icon) of the executed setup wizard. Further, a third HID action message may indicate the selection of a third icon (e.g., “Skip” icon). As an example, to identify a “click” on a particular portion of a user interface, the selected workflow may include an indication such as “click 183 465” indicating a click at row 183, column 465, of a user interface.

In some instances, the workflow data will indicate a pause between HID messages. For instance, the workflow data may indicate to pause 30 seconds between transmitting the first HID action message, and the second HID action message (e.g., to allow the executed application time to process the first HID action message, to allow the executed setup wizard to update the user interface, etc.). As an example, the selected workflow may include an indication such as “click 183 465 t:2732,” where the “t:2732” indicates a time (e.g., in micro-seconds, mill-seconds, etc.) to pause after transmitting the corresponding HID action message.

The workflow data, in some examples, may indicate the scrolling of a page of a user interface. For instance, the workflow data may provide an indication such as “key 28*down enter,” which indicates that one or more HID action messages are to be generated to scroll down a user interface page by clicking the down arrow key twenty eight times, and then performing a “click” operation (e.g., such as to click an icon). Similarly, to scroll up, the workflow data may include an indication such as “key 10*up enter,” which indicates that the up arrow for the user interface displayed by the DUT 150 is to be clicked ten times, followed by a click of the “enter” key.

The HID action messages, as described herein, may identify a location of a user interface's page to engage (e.g., click). A receiving device, such as DUT 150, processes a HID action message indicating the selection of a page location to have a similar effect as if a user had selected (e.g., clicked) that same location. As such, rather than having a user provide input (e.g., with a finger, stylus, etc.) to a user interface, the HID action messages allow for automatic user interface selections.

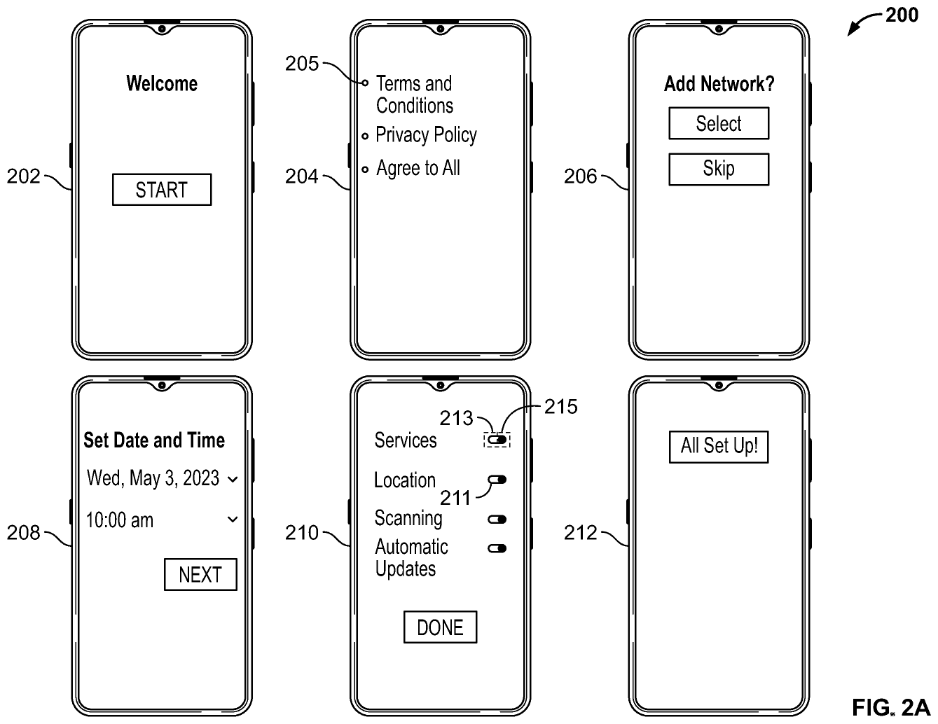

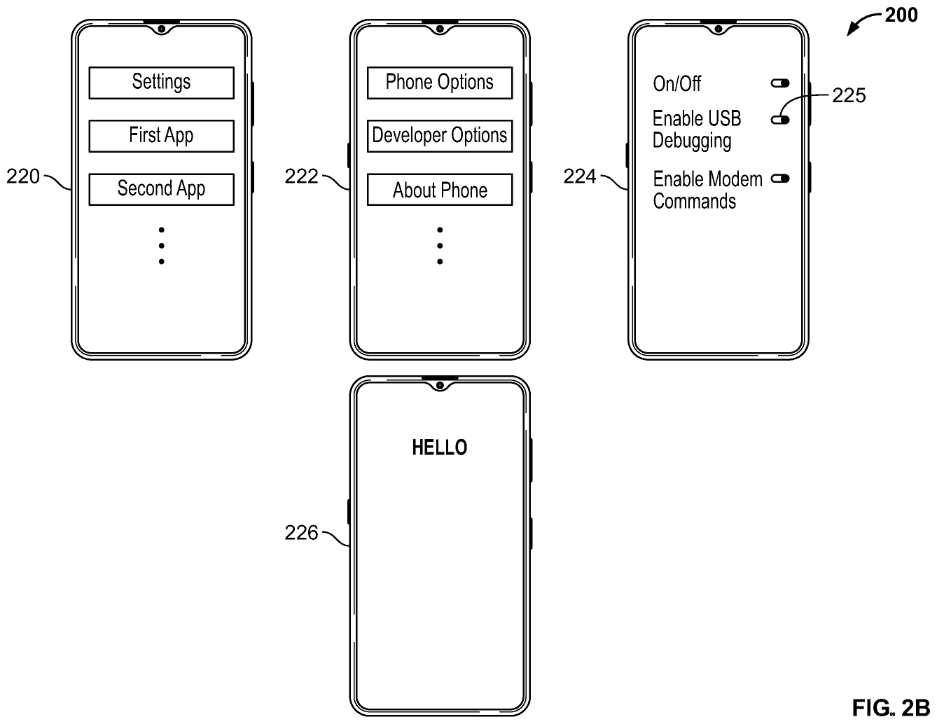

For instance, FIG. 2A illustrates various exemplary pages (e.g., webpages) of a user interface 200 displayed by a DUT 150. The user interface 200 may be displayed for a corresponding “Setup Wizard,” for example. As illustrated, a first page 202 includes a “Welcome” screen along with a “Start” icon. The testing computing device 108 may generate a HID action message to click the “Start” icon. The HID action message may specific a location of the “Start” icon (e.g., a pixel row and pixel column of first page 202). The testing computing device 108 may then transmit the HID action message to a DUT 150, causing the DUT 150 to process the HID message to engage the “Start” icon. In some examples, the DUT 150 may proceed to a second page, such as second page 204. In this example, second page 204 includes various items for acceptance, such as “Terms and Conditions” a “Privacy Policy,” each which can be accepted/acknowledged by engaging the appropriate selection icon 205. The second page 204 also includes an option to “Agree to All” by selecting the corresponding selection icon. Based on the workflow data, the testing computing device 108 may generate and transmit to the DUT 150 one or more HID action messages to select any of these selection icons. For instance, the HID action message may identify a selection (e.g., a click) of a location where any of the selection icons appear within the second page 204 (e.g., as defined by a pixel row and pixel column).

Similarly, the user interface 200 may then proceed to display a third page 206 that includes a “Select” icon and a “Skip” icon. Based further on the workflow data, the testing computing device 108 may generate and transmit to the DUT 150 a HID action message to select either the “Select” icon of the “Skip” icon. The user interface 200, upon receiving the HID action message identifying the selection, may perform operations based on the selected icon, and may proceed to display fourth page 208. As illustrated, the fourth page 208 allows for the setting of a date and time. The testing computing device 108 may, based on the workflow data, generate and transmit one or more HID action messages to the DUT 150 to cause the DUT 150 to set a date and/or time, or to have the “Next” icon engaged to proceed to the fifth page 210.

The fifth page 210 allows for the enabling/disabling of various services, such as “Location,” “Scanning,” and “Automatic Updates” services. Each service has a corresponding selection icon 211. The workflow data may include an indication to enable one or more of the services of fifth page 210. The testing computing device 150 may determine, based on the workflow data, which services to enable, and may generate and transmit one or more HID action messages to the DUT 150 to enable and/or disable corresponding services. Each HID action message may identify a location of a selection icon 211 to engage. For example, to enable “Scanning” services, a HID action message may identify a pixel location 213 to click. To disable “Scanning” services, a HID action message may identify a pixel location 215 to click. The workflow data may further include an indication to select a location of the “Done” icon. The testing computing device 108 may generate and transmit to the DUT 150 a HID action message that indicates a selection of an area of the user interface 210 that includes the “Done” icon, and when processed by the DUT 150, may cause the user interface 200 to proceed to the sixth page 212 indicating that setup is complete (e.g., the executed “Setup Wizard” has completed).

FIG. 2B illustrates other example pages of the user interface 200. For example, a seventh page 220 may include a “Settings” icon among other Application “App” icons. The workflow data may indicate a selection of a location of the seventh page 220 that includes the “Settings” icon. The testing computing device 108, based on the workflow data, may generate and transmit to the DUT 150 a HID action message to select the “Settings” icon. The HID action message causes the DUT 150 to select the “Settings” icon, and further causes the DUT 150 to proceed to the eighth page 222. The eighth page 222 includes icons for “Phone Options,” “Developer Options,” and “About Phone,” among others. The workflow data may include indications to select one or more of these icons. For example, the workflow data may include an indication to select the “Developer Options” icon. Based on the workflow data, the testing computing device 108 may generate and transmit a HID action message to the DUT 150 indicating a selection of a location of the “Developer Options” icon. Based on receiving the HID action message, the DUT 150 may perform operations to select the “Developer Options” icon, and may proceed to display ninth page 224.

As illustrated, ninth page 224 allows for the enabling and/or disabling of various options. In this example, ninth page 224 includes an “On/Off” selection icon, an “Enable USB Debugging” selection icon, and an “Enable Modem Commands” selection icon. Based on the workflow data, the testing computing device 108 may generate and transmit to the DUT 150 one or more HID action messages to enable and/or disable any of these selection icons. For instance, and as described herein, a HID action message may indicate a click of an area of selection icon 225 to enable “Enable USB Debugging.” Based further on the workflow data, the testing computing device 108 may generate and transmit to the DUT 150 a HID action message to click an area of the “Restart” icon. The DUT 150 may process the HID action messages, causing the DUT 150 to execute the user interface 200 as if the icons were selected via input from a user. Based on receiving the HID action message indicating a click of the “Restart” icon, the DUT 150 may restart, and display the tenth page 226.

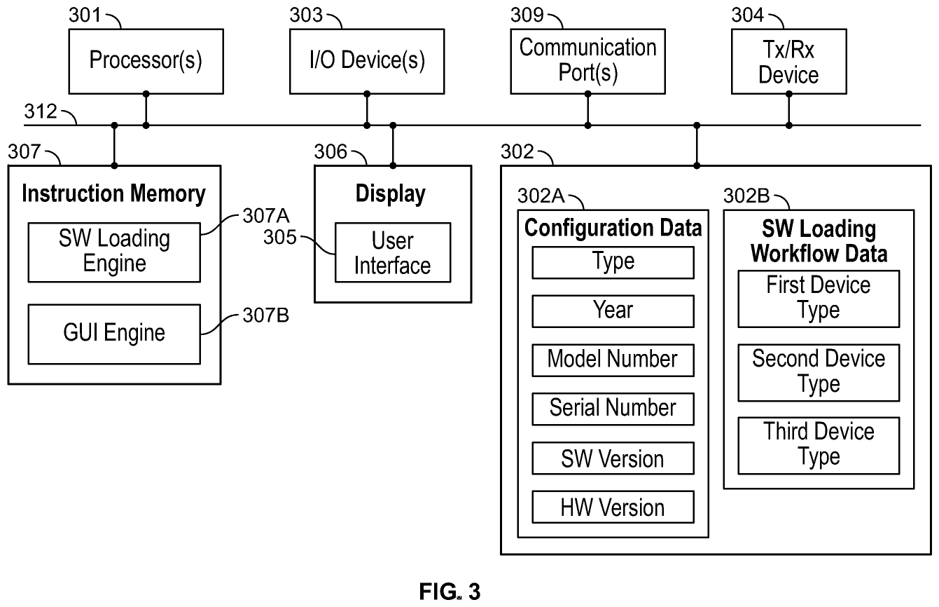

FIG. 3 illustrates an example of the testing computing device 108 of FIG. 1. Testing computing device 108 can include one or more processors 301, working memory 302, one or more input-output devices 303, instruction memory 307, a transceiver 304, one or more communication ports 309, and a display 306, all operatively coupled to one or more data buses 312. Data buses 312 allow for communication among the various devices, and can include wired, or wireless, communication channels.

Processors 301 can include one or more distinct processors, each having one or more cores. Each of the distinct processors can have the same or different structure. For example, processors 301 can include one or more central processing units (CPUs), one or more graphics processing units (GPUs), one or more application specific integrated circuits (ASICs), one or more digital signal processors (DSPs), and the like. Further, processors 301 can be configured to perform a certain function or operation by executing code, stored on instruction memory 307, embodying the function or operation. For example, processors 301 can be configured to perform one or more of any function, method, or operation disclosed herein.

Instruction memory 307 can store instructions that can be accessed (e.g., read) and executed by one or more processors 301. For example, instruction memory 307 can be a non-transitory, computer-readable storage medium such as a read-only memory (ROM), an electrically erasable programmable read-only memory (EEPROM), flash memory, a removable disk, CD-ROM, any non-volatile memory, or any other suitable memory. In this example, instruction memory 307 includes a software loading engine 307A and a GUI engine 307B.

Software loading engine 307A may include instructions that, when executed by one or more of processors 301, cause the one or more processors 301 to perform operations to generate and transmit messages to DUTs 150, as well as receive and process configuration data, as described herein. For instance, one or more processors 301 may execute software loading engine 307A to transmit firmware update messages, HID action messages, and debug messages to one or more DUTS 150. In addition, GUI engine 307B can include instructions that, when executed by one or more of processors 301, cause the one or more processors 301 to perform operations to generate a user interface 305, and to display the user interface 305 on display 306 (e.g., monitor 126). Further, the executed GUI engine 307B may allow a user to select operations to be performed on one or more DUTs 150, as well as to view status, such as wireless status, of the one or more DUTs 150, as described herein.

Additionally, processors 301 can store data to, and read data from, working memory 302. For example, processors 301 can store a working set of instructions to working memory 302, such as instructions loaded from instruction memory 307. Processors 301 can also use working memory 302 to store dynamic data created during the operation of testing computing device 108. Working memory 302 can be a random access memory (RAM) such as a static random access memory (SRAM) or dynamic random access memory (DRAM), or any other suitable memory.

As illustrated in this example, working memory 302 may store configuration data 302A and software loading workflow data 302B. Configuration data 302A may include configuration data for DUTs 150, such as configuration data received in response to configuration request messages, as described herein. Configuration data 302A may include, for each DUT 150, one or more of a device type (e.g., personal computer, laptop, tablet, etc.), a year of manufacturer, a model number, a serial number, a software version, and a hardware version, among any other device identifying information. Software loading workflow data 302B may identify and characterize a workflow for each type of DUT 150. As described herein, each workflow may identify a particular message sequence for the type of DUT 150.

Input-output devices 303 can include any suitable device that allows for data input or output. For example, input-output devices 303 can include one or more of a keyboard, a touchpad, a mouse, a stylus, a touchscreen, a physical button, a microphone, or any other suitable input or output device.

Communication port(s) 309 can include, for example, a serial port such as a Universal Serial Bus (USB) port, an Ethernet port, a universal asynchronous receiver/transmitter (UART) port, or any other suitable communication port or connection. In some examples, communication port(s) 309 allows for the programming of executable instructions in instruction memory 307. In some examples, communication port(s) 309 allow for the transfer (e.g., uploading or downloading) of data, such as data stored within working memory 302.

Display 306 can display user interface 305. User interface 305 can enable user interaction with testing computing device 108. For example, user interface 305 can be a user interface for an application that allows the user to enable one or more operations, and to select one or more DUTs 150, as described herein. In some examples, a user can interact with user interface 305 by engaging input-output devices 303. In some examples, display 306 can be a touchscreen, where user interface 305 is displayed on the touchscreen.

Transceiver 304 allows for communication with a network, such as a wireless communication network (e.g., WiFi®, Bluetooth®, etc.). The one or more processors 301 are operable to receive data from, and send data to, a wireless network via transceiver 304.

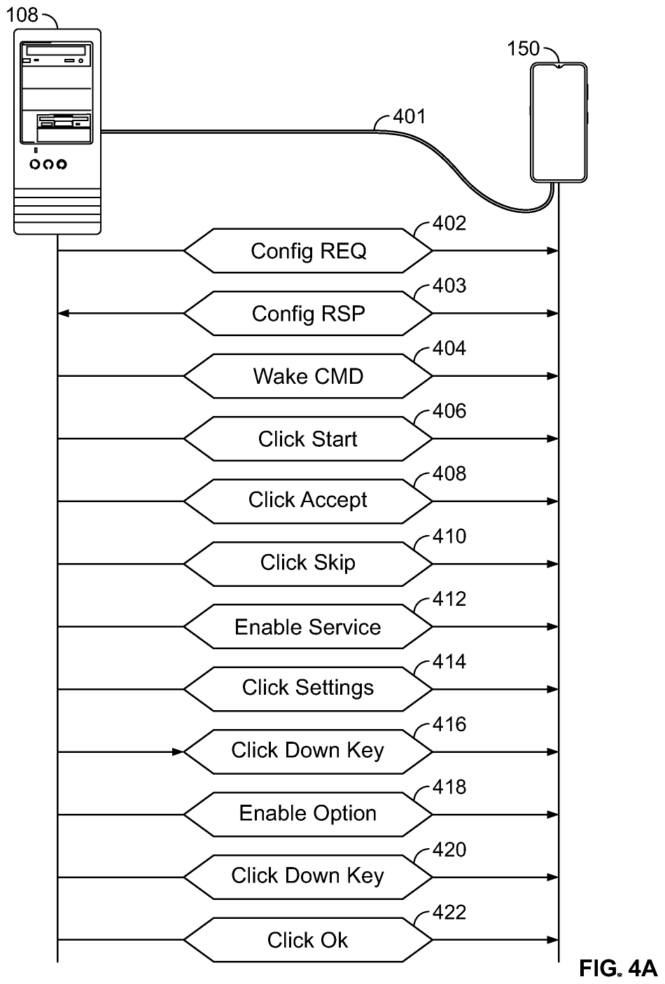

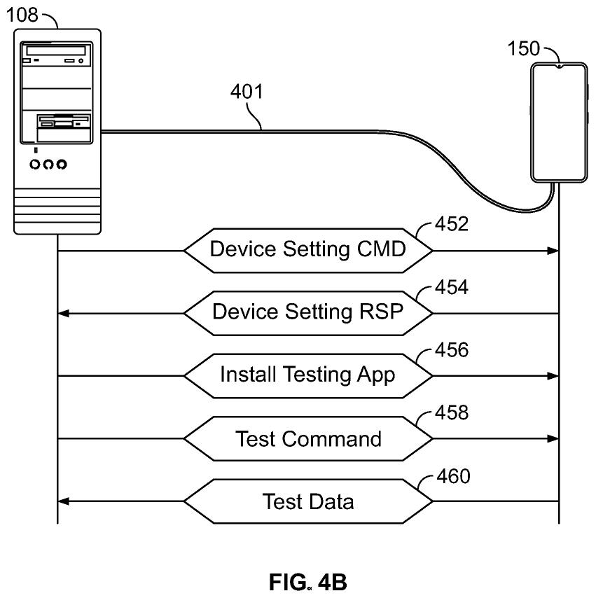

FIGS. 4A and 4B illustrate exemplary messaging between the testing computing device 108 and a DUT 150. As described herein, the testing computing device 108 may be communicatively coupled to the DUT 150 using one or more cables 401. The testing computing device 108 may be configured to transmit messages to the DUT 150, such as to update firmware, execute an application (e.g., setup wizard), and to install a testing application for execution.

For instance, and with reference to FIG. 4A, the testing computing device 108 may generate and transmit a configuration request message to the DUT 150. In response, the DUT 150 may generate and transmit a configuration response message to the testing computing device 108. The configuration response message may include configuration data, such as one or more fields of configuration data 302A. The testing computing device 108 may receive the configuration response message 403, and may parse the configuration response message 403 to extract the configuration data. Moreover, based on the extracted configuration data, the testing computing device 108 may select one of a multitude of workflows. For example, a database, such as a cloud-based database, may store software loading workflow data 302B for each of a plurality of various DUT 150 types. The testing computing device 108 may select and obtain the software loading workflow data 302B pertaining to DUT 150 (e.g., based on DUT's 150 type) from the database. The testing computing device 108 may then perform operations in accordance with the selected software loading workflow data 302B.

For example, the software loading workflow data 302B may indicate that a “wake” command should be transmitted. Thus, testing computing device 108 may generate and transmit the wake command 404 to the DUT 150. The wake command may cause the DUT 150 to move from a lower power state (e.g., a sleep state) to a higher power state (e.g., a fully functional state). Further, the software loading workflow data 302B may indicate that a “Start” icon located within a portion of a user interface is to be selected. The testing computing device 108 may generate and transmit to the DUT 150 a HID action message 406 that indicates a selection of “Start” icon. The DUT 150, upon receiving the HID action message, may perform operations that correspond to the selection of the “Start” icon. As described herein, in some examples, the software loading workflow data 302B indicates an amount of time before processing the next transmission. For instance, in this example, the software loading workflow data 302B may indicate to pause for thirty seconds after transmitting the HID action message 406.

Similarly, and based on the software loading workflow data 302B, the testing computing device 108 may generate and transmit a HID action message 408 to select an “Accept” icon, and thereafter to generate and transmit another HID action message 410 to select a “Skip” icon. Further, and based on the software loading workflow data 302B, the testing computing device 108 may generate and transmit a HID action message 412 to enable a service, and may generate and transmit another HID action message 414 to select a “Settings” icon. The testing computing device 108 may then, based on the software loading workflow data 302B, generate and transmit a HD action message 416 to engage the down key (e.g., to scroll down a page of a user interface).

Further, the testing computing device 108 may generate and transmit to the DUT 150 a HID action message 418 to enable an option (e.g., USB debugging). For instance, the HID action message 418 may indicate a portion of the user interface that, when clicked, enables the option. The testing computing device 108 may also generate and transmit to the DUT 150 another HID action message 420 to engage the down key. Further, the software loading workflow data 302B may include an indication to click an “OK” icon at a particular location of the user interface. The testing computing device 108 may generate a HID action message 422 based to click the “OK” icon at the particular location, and may transmit the HID action message 422 to the DUT 150.

FIG. 4B illustrates messaging between the testing computing device 108 and the DUT 150 to install a testing application on the DUT 150. In this example, rather than HIS action messages, the testing computing device 108 may generate and transmit debug messages (e.g., Android® Debug Bridge commands) to the DUT 150. The debug messages may be generated according to a format, such as one supported by a software library.

In this example, the testing computing device 108 generates and transmits a device setting command 452 that identifies one or more device configuration values for one or more device configuration settings. The device configuration settings may control the installing and/or de-installing of applications. The DUT 150 may receive the device setting command 452, set the device configuration settings according to the received device configuration values, and generate and transmit a device setting response 454 to the testing computing device 108. The device setting response 454 may identify and characterize whether the device configuration settings were updated successfully.

Further, the testing computing device 108 may generate one or more debug messages 456. The debug messages 456 may be generated in accordance with a messaging format, such as Android® Debug Bridge commands (e.g., when the DUT 150 is in a debug mode). For instance, each debug message 456 may include a portion of executable instructions that, when executed by one or more processors, establish a testing application. The testing computing device 108 may transmit the one or more debug messages 456 to the DUT 150 (e.g., sequentially). DUT 150 may extract the portions of executable instructions received in the one or debug messages 456, and perform operations to install the testing application (e.g., by writing the executable instructions to an instruction memory).

Once the DUT 150 has installed the testing application, the testing computing device 108 may perform operations to test the DUT 150. For example, the testing computing device 150 may transmit a test command 458 to the DUT 150. The test command 458 may identify one or more tests for the DUT 150 to execute. For example, the test command 458 may indicate a memory test (e.g., writing values to memory and reading the values back from memory to determine whether they match), a network test (e.g., a wireless network test to test transmission and reception), a port or network connectivity test (e.g., a USB or Ethernet transmission and reception test), or any other suitable test. Upon receiving the test command 458, the DUT 150 may execute the identified one or more tests. Further, the DUT 150 may generate test data 460 characterizing the results of the one or more tests (e.g., test passed, test failed, test values, etc.), and may transmit the test data 460 to the testing computing device 108. In some examples, the testing computing device 108 displays at least portions of the received test data 460 (e.g., on monitor 126).

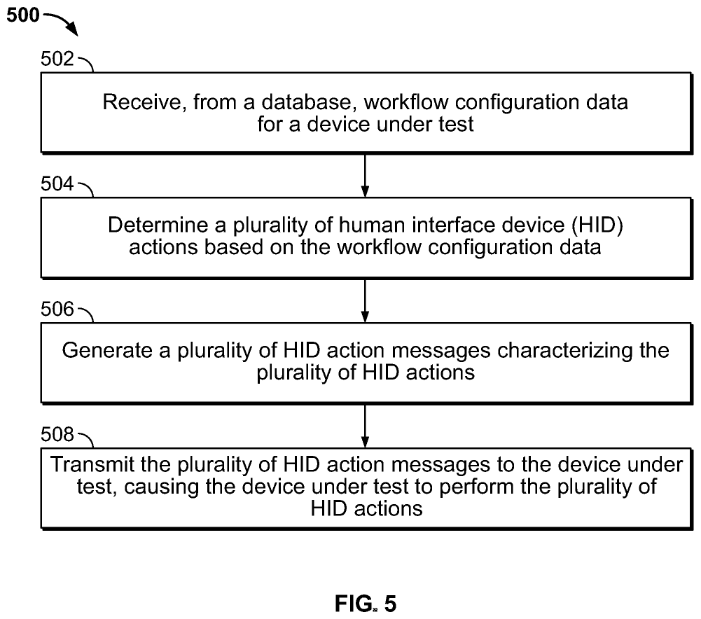

FIG. 5 is a flowchart of an exemplary process 500 to automatically load software onto a device under test, such as a DUT 150. The exemplary process 500 may be performed, for instance, by the testing computing device 108. For example, beginning at block 502, the testing computing device 108 receives, from a database, workflow configuration data for a device under test. The testing computing device 108 may determine the workflow configuration data for the device under test based on configuration data received for the device under test, as described herein. At block 504, the testing computing device 108 determines a plurality of human interface device (HID) actions based on the workflow configuration data. For example, based on the workflow configuration data, the testing computing device 108 may determine a HID action to click a particular location of a page of a user interface, such as where a particular icon is located.

Proceeding to block 506, the testing computing device 108 generates a plurality of HID action messages charactering the plurality of HID actions determined at block 504. At block 508, the testing computing device 108 transmits the plurality of HID action messages to the device under test, causing the device under test to perform the plurality of HID actions.

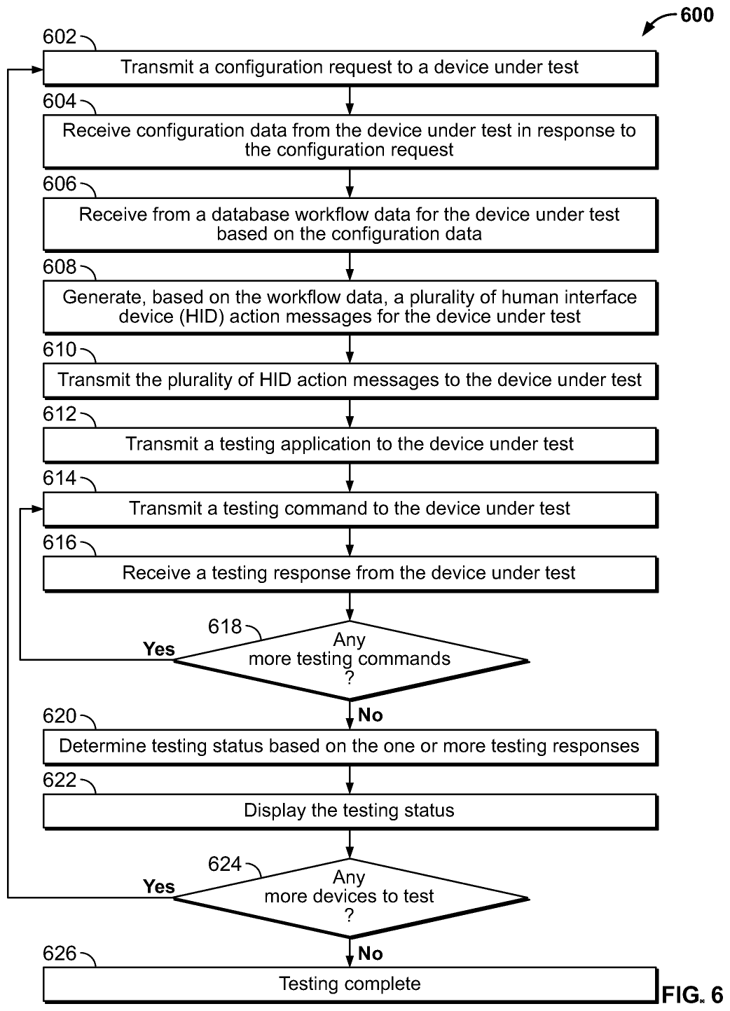

FIG. 6 is a flowchart of an exemplary process 600 to automatically load software onto a plurality of devices under test, such as DUTs 150. The exemplary process 600 may be performed, for instance, by the testing computing device 108. For example, beginning at block 602, the testing computing device 108 transmits a configuration request, such as configuration request 402, to a device under test. The configuration request causes the device under test to obtain and transmit configuration data to the testing computing device 108. At block 604, the testing computing device 108 receives the configuration data from the device under test. The configuration data may include, for example, a device type, a device year, a model number, a serial number, a software version, a hardware version, or any other suitable configuration data 302A.

At block 606, the testing computing device 108 receives from a database workflow data for the device under test based on the configuration data. For example, the testing computing device 108 may determine a device type of the device under test based on the received configuration data. Further, and based on the device type, the testing computing device 108 may determine and obtain corresponding workflow data for the device under test. At block 608, the testing computing device 108 generates, based on the workflow data, a plurality of human interface device (HID) action messages for the device under test. As described herein, the plurality of HID action messages may correspond to various pages of an application, such as a setup wizard.

Proceeding to block 610, the testing computing device 108 transmits the plurality of HID action messages to the device under test, e.g., simultaneously, in accordance with the workflow data. Further, at block 612, the testing computing device 108 transmits a testing application to the device under test. For instance, after the last of the HID action messages was transmitted to the device under test, the device under test may have restarted. After restarting, the testing computing device 108 may transmit debug messages 456 that include portions of executable instructions that characterize the testing application.

At block 614, the testing computing device 108 transmits a testing command to the device under test. As described herein, the testing command may cause the device under test to perform one or more tests, such as a hardware and/or software testing and/or verification operations. Further, the device under test may generate and transmit a testing response to the testing computing device 108, where the testing response may include a status of one or more of the tests performed. At block 616, the testing computing device 108 receives the testing response from the device under test.

Proceeding to block 618, the testing computing device 108 determines whether there are any more testing commands to transmit to the device under test. If there is an additional testing command to transmit to the device under test, the method proceeds back to block 614 to transmit the additional testing command. If there are no additional testing commands to transmit, the method proceeds to block 620 where the testing computing device 108 determines a testing status based on the one or more received testing responses. For instance, the testing computing device 108 may determine, for each test, whether the test passed or failed, and may determine whether the device under test passed or failed the testing and verification overall, based on the received responses.

At block 622, the testing computing device 108 displays the testing status. For example, the testing computing device 108 may display the testing status on monitor 126. The method then proceeds to block 624, where the testing computing device 108 determines whether there are any more devices to test. For instance, the testing computing device 108 may determine whether any more DUTs 150 within the testing system 100 remain to be tested. In some examples, the testing computing device 108 detects whether there are any additional DUTs 150 to test based on transmitting a configuration request message to a DUT 150. The testing computing device 108 detects the DUT 150 if configuration data is received from the DUT 150, e.g., within a predetermined amount of time (e.g., 5 seconds, 10 seconds, 30 seconds). If there are any more devices to test, the method proceeds back to block 602. Otherwise, testing is complete at block 626.

Advantageously, the embodiments described herein allow for the automatic configuration of devices under test to, for instance, load software, such as firmware and applications, onto the devices under test. The embodiments may also allow for the testing of the functionality of the devices under test based on the loaded software.

Although the methods described above are with reference to the illustrated flowcharts, it will be appreciated that many other ways of performing the acts associated with the methods can be used. For example, the order of some operations may be changed, and some of the operations described may be optional.

In addition, the methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROM, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

The foregoing is provided for purposes of illustrating, explaining, and describing embodiments of these disclosures. Modifications and adaptations to these embodiments will be apparent to those skilled in the art and may be made without departing from the scope or spirit of these disclosures.

What is claimed:

1. An apparatus comprising:
a memory device storing executable instructions; and
at least one processor communicatively coupled to the memory device and configured to execute the instructions to:
receive, from a database, workflow data for a device under test;
determine a plurality of human interface device (HID) actions based on the workflow data;
transmit the plurality of HID actions to the device under test, causing the device under test to perform one or more configuration operations.

2. The apparatus of claim 1, wherein the at least one processor is configured to execute the instructions to:
transmit a configuration request to the device under test;
receive configuration data from the device under test in response to the configuration request; and
determine the workflow data for the device under test based on the configuration data.

3. The apparatus of claim 2, wherein the configuration data comprises at least one of a device type, a model number, a software version, a hardware version, and a year of manufacturer.

4. The apparatus of claim 1, the plurality of HID actions comprise a first HID action to engage a location of a page of a user interface.

5. The apparatus of claim 4, wherein the first HID action includes a pixel row location and a pixel column location.

6. The apparatus of claim 5, wherein the first HID action includes a time to pause after transmitting the first HID action.

7. The apparatus of claim 1, wherein the at least one processor is configured to execute the instructions to:
transmit firmware update messages to the device under test, each firmware update message comprising a portion of executable instructions characterizing firmware;
determine the device under test has restarted; and
transmit the plurality of HID actions to the device under test based on determining the device under test has restarted.

8. The apparatus of claim 1, wherein the at least one processor is configured to execute the instructions to:
determine the device under test has restarted; and
transmit debug messages to the device under test to install a testing application.

9. The apparatus of claim 1, wherein the at least one processor is communicatively coupled to the device under test by one or more communication cables.

10. The apparatus of claim 1, wherein the workflow data characterizes one or more engagements of one or more icons of one or more pages of a user interface displayed by the device under test.

11. A method by at least one processor, the method comprising:
receiving, from a database, workflow data for a device under test;
determining a plurality of human interface device (HID) actions based on the workflow data; and
transmitting the plurality of HID actions to the device under test, causing the device under test to perform one or more configuration operations.

12. The method of claim 11, comprising:
transmitting a configuration request to the device under test;
receiving configuration data from the device under test in response to the configuration request; and
determining the workflow data for the device under test based on the configuration data.

13. The method of claim 11, comprising:
transmitting firmware update messages to the device under test, each firmware update message comprising a portion of executable instructions characterizing firmware;
determining the device under test has restarted; and
transmitting the plurality of HID actions to the device under test based on determining the device under test has restarted.

14. The method of claim 11, comprising:
determining the device under test has restarted; and
transmitting debug messages to the device under test to install a testing application.

15. The method of claim 11, wherein the plurality of HID actions comprise a first HID action to engage a location of a page of a user interface, and wherein the first HID action includes a pixel row location, a pixel column location, and a time to pause after transmitting the first HID action.

16. A testing system comprising:
a testing frame with a plurality of cabinets, each of the plurality of cabinets housing a device under test; and
a testing computing device commutatively coupled to each of the devices under test, wherein the testing computing device is configured to:
receive, from a database, workflow data for each of the devices under test;
determine, for each of the devices under test, a plurality of human interface device (HID) actions based on the workflow data corresponding to each device under test; and
transmit to each of the devices under test the corresponding plurality of HID actions, causing each of the devices under test to perform one or more configuration operations.

17. The testing system of claim 16, wherein the testing computing device is configured to:
transmit a configuration request to the device under test;
receive configuration data from the device under test in response to the configuration request; and
determine the workflow data for the device under test based on the configuration data.

18. The testing system of claim 16, wherein the testing computing device is configured to simultaneously communicate with each of the devices under test.

19. The testing system of claim 18, where each of the devices under test comprise a first device under test and a second device under test, wherein the first device under test is of a first device type, and the second device under test is of a second device type, the first device type different than the second device type.

20. The testing system of claim 16, wherein each of the devices under test perform the one or more configuration operations independently from each other.
